(19) United States
(12) Patent Application Publication
(10) Pub. No.: US 2009/0248877 A1
(43) Pub. Date: Oct. 1, 2009

(54) CONTENT PROCESSING APPARATUS AND METHOD

(75) Inventor: Kazuhiro MINO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/411,050

(22) Filed: Mar. 25, 2009

(30) Foreign Application Priority Data
Mar. 26, 2008 (JP) 2008-081447

(51) Int. Cl. G06F 15/173

(52) U.S. Cl. 709/226

(57) ABSTRACT

The content processing apparatus and method perform an operation instruction for contents by using at least one operation unit, allocate corresponding pattern identification information to an operation pattern of the at least one operation unit, store the operation pattern and the pattern identification information allocated to the operation pattern related to each other, acquire, when the operation instruction is performed, the pattern identification information based on the operation pattern of the operation instruction and the stored operation pattern and execute processing of the contents based on the operation instruction.

### BACKGROUND OF THE INVENTION

The present invention relates to a content processing apparatus and a content processing method for applying processing, that is, applying modifications (or actions) to contents uploaded to a server and the like on a network, and more particularly, to a content processing apparatus and a content processing method that can identify who has made the modification and what has done to each content and record an operation state.

In the past, there have been proposed various content processing systems with which users apply modifications such as viewing and editing to various contents such as images, sound, and moving images stored in PCs and servers and the like on networks. In such systems, there is also proposed a method with which, when a user performs operation using an operation device such as a keyboard or a mouse, the user easily performs a modification as the modification associated with the operation is executed.

For example, JP 2007-82020 A discloses an information display apparatus that displays, according to details of an input to operation displaying means such as a touch panel, setting information associated with the input details. In the information display apparatus disclosed in JP 2007-82020 A, setting information is determined on the basis of a position of touch input, touch time, and the like in the input to the operation displaying means.

JP2005-202966 A discloses a method and an apparatus for executing a plurality of file management operations that can simultaneously apply a plurality of operations to different files and execute the assigned operations at an execution stage. In the method and the apparatus disclosed in JP 2005-202966 A, different operations are associated with predetermined key inputs by a keyboard, respectively, and, every time an operation by a key input is applied to an arbitrary file, for example, a different color is displayed in vicinity of an area where a file name corresponding to the file is displayed to associate an identifiable visually-displayed characteristic with the file. Further, when execution is instructed, operations for all selected files are executed.

### SUMMARY OF THE INVENTION

However, in the methods in the past disclosed in JP 2007-82020 A and JP 2005-202966 A, types of inputs by the touch panel and the keyboard together with setting information and details of modifications are stored in association with each other in advance. A user cannot arbitrarily change the types of inputs or change an association between the types of inputs and the setting information or the details of modifications. Therefore, there is a problem in that, the system cannot additionally include new processing function properly.

In such the system, it is conceivable that a plurality of users apply operations to the same file and the like. However, in the methods in the past, the users cannot be identified. Therefore, there is a problem also in that, when the plurality of users perform modifications, operations are complicated.

It is an object of the present invention to solve the above-mentioned problems of the technologies in the past and provide a content processing apparatus and a content processing method with which a user can arbitrarily set a type of an input and that can cope with respective operations performed by a plurality of users.

In order to solve the above-described problems, the present invention provides a content processing apparatus comprising: at least one operation means for performing an operation instruction for contents; pattern allocating means for allocating corresponding pattern identification information to an operation pattern of the at least one operation means; pattern storing means for storing the operation pattern and the pattern identification information allocated to the operation pattern related to each other; pattern recognizing means for acquiring, when the operation instruction by the at least one operation means is performed, the pattern identification information based on the operation pattern of the operation instruction by the at least one operation means and the operation pattern stored in the pattern storing means; and operation executing means for executing processing of the contents based on the operation instruction by the at least one operation means.

In the present invention, preferably, the pattern allocating means allocates the pattern identification information to the operation pattern of the at least one operation means.

Or, preferably, the pattern allocating means automatically sets the operation pattern operable in the at least one operation means and allocates the pattern identification information to the set operation pattern at random.

In addition, preferably, the pattern identification information is identification information of a user.

Or, preferably, the pattern identification information is identification information of details of an operation instruction of the at least one operation means.

It is preferable that the content processing apparatus further comprise reference-pattern storing means for storing, as reference patterns, a plurality of operation patterns set in advance, wherein the pattern storing means extracts a reference pattern most similar to an operation pattern of the at least one operation means out of the reference patterns and stores the extracted reference pattern, a difference between the reference pattern and the operation pattern of the at least one operation means, and the pattern identification information related to one another.

It is preferable that the content processing apparatus further comprise pattern changing means for changing setting of the operation pattern stored in the pattern storing means.

And, it is preferable that the content processing apparatus further comprise recognition-result displaying means for displaying the identification information acquired by the pattern recognizing means and the operation pattern.

Preferably, processing of the contents by the at least one operation means is selection or editing processing of the contents.

It is preferable that the content processing apparatus further comprise operation-information recording means for recording details of the processing executed by the operation executing means related to the pattern identification information.

In addition, preferably, the at least one operation means performs the operation instructions for the contents via a network; and at least one user accesses the contents via the network by using the at least one operation means and performs processing of the contents.

And, the present invention provides a content processing method comprising: performing an operation instruction for contents by using at least one operation means; allocating corresponding pattern identification information to an operation pattern of the at least one operation means; storing the operation pattern and the pattern identification information allocated to the operation pattern related to each other; acquiring, when the operation instruction is performed by using the at least one operation means, the pattern identification information based on the operation pattern of the operation instruction and the operation pattern stored related to the pattern identification information; and executing processing of the contents based on the operation instruction.

With the content processing apparatus and the content processing method according to the present invention, a user can arbitrarily set a type of an input, and hence the user can perform processing operation for contents in a form more convenient for the user. Further, even when modifications are applied to the same content by a plurality of users, it is possible to record and manage which users performed the respective modifications and prevent operations from becoming complicated.

### BRIEF DESCRIPTION OF THE DRAWINGS

In the accompanying drawings:

FIG. 1 is a block diagram of an example of an apparatus configuration of a content processing apparatus according to the present invention;

FIG. 2 is a flowchart of an example of a flow of a method of registering an operation pattern;

FIG. 3 is a diagram of a setting method selection screen;

FIGS. 4A to 4C are diagrams of examples of setting screens displayed according to allocation by person;

FIG. 5 is a diagram of an example of a setting screen displayed according to allocation by person;

FIG. 6 is a diagram of an example of a setting screen displayed according to allocation by operation and modification;

FIG. 7 is a flowchart of another example of the flow of the method of registering an operation pattern;

FIG. 8 is a flowchart of still another example of the flow of the method of registering an operation pattern;

FIG. 9 is a diagram of an example of a screen during content modification; and

FIG. 10 is a diagram of another example of the screen during content processing.

### DETAILED DESCRIPTION OF THE PREFERRED EMBODIMENT

A content processing apparatus according to the present invention that realizes a content processing method according to the present invention is described in detail below on the basis of preferred embodiments illustrated in the accompanying drawings.

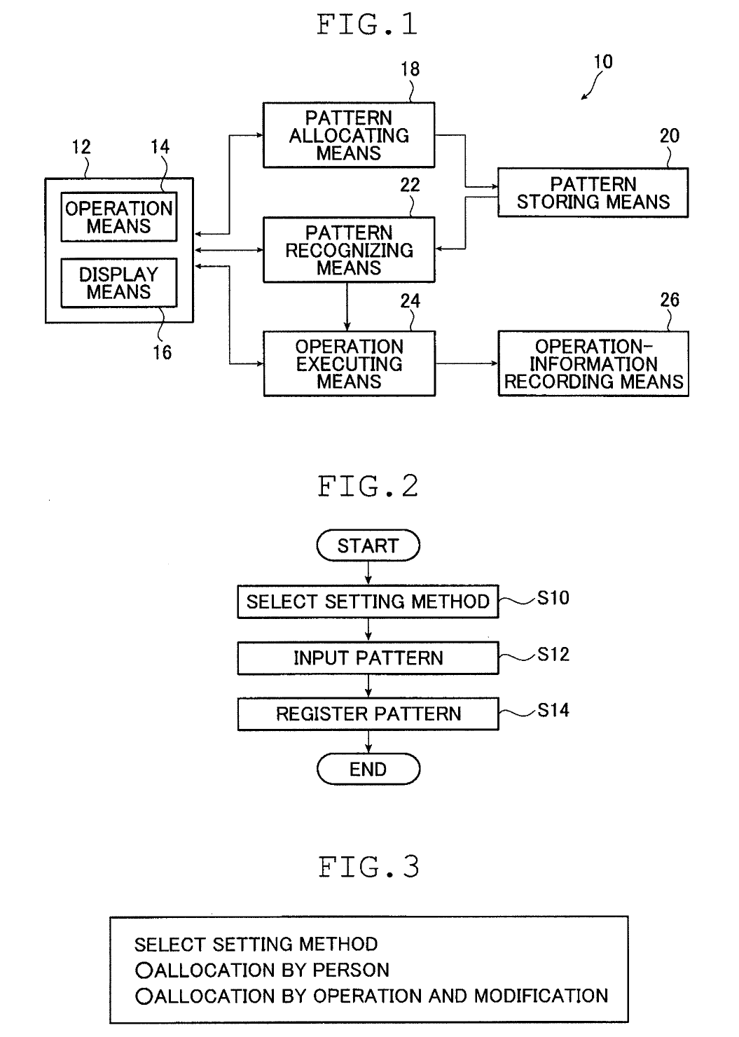

FIG. 1 is a block diagram of an embodiment of an apparatus configuration of the content processing apparatus that realizes the content processing method according to the present invention.

A content processing apparatus 10 (hereinafter referred to as processing apparatus 10) illustrated in FIG. 1 is an apparatus that deals with contents such as images, sound, moving images, and various files. The processing apparatus 10 is, for example, a personal computer (PC), a display apparatus such as a monitor that can be operated through the Internet, or a display apparatus such as a table-like landscape monitor.

The processing apparatus 10 includes an operation instructing unit 12, pattern allocating means 18, pattern storing means 20, pattern recognizing means 22, operation executing means 24, and operation-information recording means 26.

The operation instructing unit 12 includes operation means 14 and display means 16.

The operation means 14 instructs modifications when contents are modified in the processing apparatus 10. The operation means 14 may be publicly-known means such as a mouse, a keyboard, a touch pen, a touch pad, a trackball, and a remote controller by infrared-ray communication.

The display means 16 is a publicly-known display device such as a monitor for displaying information necessary for a user such as details of contents and modification information. The display means 16 performs various kinds of display according to instructions from the pattern allocating means 18, the pattern recognizing means 22, and the operation executing means 24.

A user processes the contents by operating the operation means 14 while looking at the display means 16.

One operation means 14 and one display means 16 may be set for one processing apparatus 10. Each of users may have one operation means 14 and one display means 16. The operation means 14 and the display means 16 may be directly connected to the processing apparatus 10. Alternatively, the processing apparatus 10 may be a content processing system that can be communicated with and operated via a network and may perform operation by the operation instructing unit 12 via the network. Even when a plurality of the display means 16 are provided, all displayed contents are the same.

The pattern allocating means 18 is means for allocating an operation pattern of the operation means 14 to pattern identification information of a content.

The operation pattern is a type of an operation of the operation means 14. For example, when the operation means 14 is a mouse, examples of the operation pattern include one-click, double-click, and triple-click. When the operation means 14 is a touch panel, the number of fingers that simultaneously touch the touch panel can be set as the operation pattern. When the operation means 14 is a pointing device such as a mouse or a touch pen, a shape of a line drawn by operating the pointing device can be set as the operation pattern.

As the operation pattern, any operation pattern may be used as long as the operation pattern can be represented by the operation means 14.

Examples of the pattern identification information include identification information of the user and a type of modification executed on contents.

The pattern allocating means 18 can change an operation pattern stored in the pattern storing means 20 described later.

Allocation of the operation pattern to the pattern identification information and change of the operation pattern are described in detail later.

The pattern storing means 20 stores the pattern identification information of the contents and the operation pattern allocated to the pattern identification information in association with each other. Each information stored in the pattern storing means 20 can be changed as appropriate in the pattern allocating means 18 as described above.

The pattern recognizing means 22 recognizes a pattern of operation performed by the user using the operation means 14 and acquires pattern identification information corresponding to the recognized operation pattern out of the information stored in the pattern storing means 20.

The operation executing means 24 executes modification of contents according to an operation instruction performed by the user using the operation means 14.

The operation-information recording means 26 records details of the modification executed in the operation executing means 24 as operation information in association with the pattern identification information.

A specific action of the content processing apparatus according to the present invention that realizes the content processing method according to the present invention is described next.

First, a method of setting an operation pattern in the processing apparatus 10 is described. A process of setting an operation pattern is illustrated in FIG. 2.

First, in step S10 in FIG. 2, in the pattern allocating means 18, the user allocates an operation pattern of the operation means 14 to pattern identification information and stores the pattern identification information and the operation pattern in the pattern storing means 20 in association with each other to set the operation pattern.

An example of a setting screen for an operation pattern is illustrated in FIG. 3.

A selection screen for a setting method illustrated in FIG. 3 is displayed on the display means 16. The user selects any one of setting methods, “allocation by person” and “allocation by operation and modification” using the operation means 14.

First, a modification to be performed when “allocation by person” is selected as the setting method is described.

“Allocation by person” means that, when a plurality of users process a single content, in order to identify which user performs what modification, identification information of each of the users is stored as pattern identification information and an operation pattern is allocated to this identification information. A user performs by the operation means 14 operation of an operation pattern allocated as identification information of the user, whereby the processing apparatus 10 can recognize which user performed the operation.

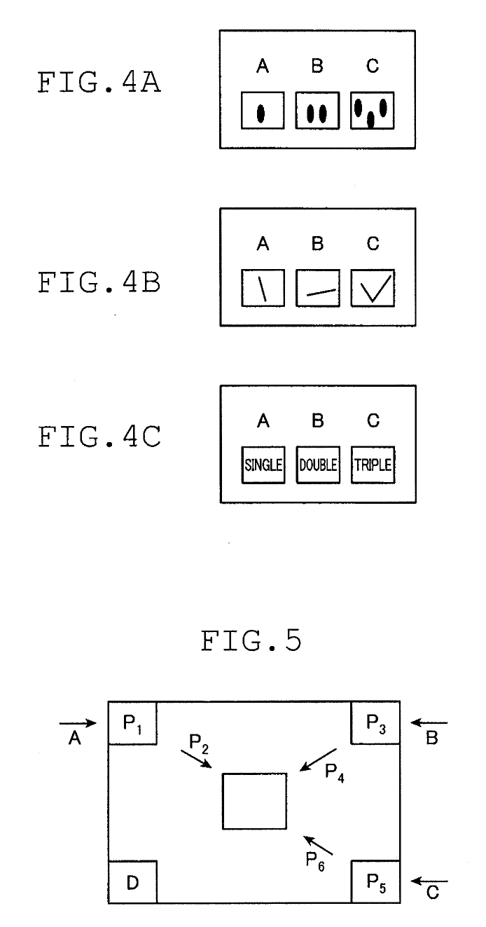

When “allocation by person” is selected on the screen illustrated in FIG. 3, setting screens for operation patterns for the respective users illustrated in FIGS. 4A to 4C are displayed according to a type of the operation means 14. Then, the user inputs an operation pattern (step S12). In FIGS. 4A to 4C, as an example, operation patterns are set for three users A, B, and C.

FIG. 4A is a diagram of a setting screen for an operation pattern displayed when the operation means 14 is the touch panel. In an example illustrated in the figure, as an operation pattern of the user A, a pattern of touching the touch panel with one finger is set. As an operation pattern of the user B, a pattern of simultaneously touching the touch panel with two fingers placed side by side is set. As an operation pattern of the user C, a pattern of simultaneously touching the touch panel with three fingers is set. In this way, according to a difference in the number of fingers that simultaneously touch the touch panel, the pattern recognizing means 22 can recognize a user who performed the operation.

FIG. 4B is a setting screen for an operation pattern displayed when the operation means 14 is the pointing device such as the mouse or the touch pen. In an example illustrated in the figure, the operation means 14 uses an operation pattern that changes with time according to the drag of the mouse or the movement of the touch pen. As an operation pattern of the user A, a pattern of moving (dragging) the operation means 14 in a longitudinal direction on the screen is set. As an operation pattern of the user B, a pattern of moving the operation means 14 in a lateral direction on the screen is set. As an operation pattern of the user C, a pattern of moving the operation means 14 in a check mark shape is set.

Further, the operation patterns are not limited to straight lines and may be, for example, wavy lines and curves. Alternatively, figures such as a circle, a triangle, and a rectangle may be used as the operation patterns.

FIG. 4C is a diagram of a setting screen for an operation pattern displayed when the operation means 14 is the mouse. In an example illustrated in the figure, as an operation pattern of the user A, a pattern of single-clicking the mouse is set. As an operation pattern of the user B, a pattern of double-clicking the mouse is set. As an operation pattern of the user C, a pattern of triple-clicking the mouse is set.

The operation patterns are not limited to those illustrated in FIGS. 4A to 4C as the examples. The operation patterns may be any operation patterns as long as the operation patterns can be expressed by the operation means 14.

All the examples described above are operation patterns for identifying a user by operating the operation means 14 once. Further, it is possible to set operation patterns by successively operating the operation means 14 twice. An example of such operation patterns is illustrated in FIG. 5.

FIG. 5 is a diagram of the display means 16 as the touch panel. When the users A, B, C, and D perform operation on this screen, as an operation pattern of the user A, first, the user A touches P1 and then touches P2. Similarly, the user B successively touches P3 and P4 and the user C successively touches P5 and P6. With such operation patterns, the processing apparatus 10 can identify the respective users. If an interval of time for touching two points is set within a fixed range, it is possible to prevent misidentification. Further, it is also possible to adopt an operation pattern of simultaneously touching two points rather than successively touching the two points.

Further, when the operation means 14 is the mouse, it is possible to set the similar patterns by clicking the respective positions on the screen.

By inputting such operation patterns and identification information of the users, it is possible to allocate and set the operation patterns by person. The input identification information and operation patterns of each user are stored in the pattern storing means 20 in association with each other to be registered as an operation pattern (step S14 in FIG. 2).

The registration of the operation patterns may be performed in forms of images as illustrated in FIGS. 4A to 4C. Alternatively, the operation patterns illustrated in FIG. 4A, form example, may be registered as information such as “touching the touch panel with one finger”.

Note that a plurality of operation patterns may be registered for one user. For example, all the operation patterns of the user A illustrated in FIGS. 4A to 4C may be stored in the pattern storing means 20.

Next, a modification to be performed when “allocation by operation and modification” is selected as the setting method on the setting method selection screen illustrated in FIG. 3 is described.

“Allocation by operation and modification” means that, when a modification of contents is performed by a user, in order to identify a modification instruction from the user, identification information of each modification is stored as pattern identification information and an operation pattern is allocated to this identification information. The user performs by the operation means 14 operation of an operation pattern allocated as identification information of the modification that the user desires to perform on the contents, whereby the processing apparatus 10 can execute the modification corresponding to the operation pattern.

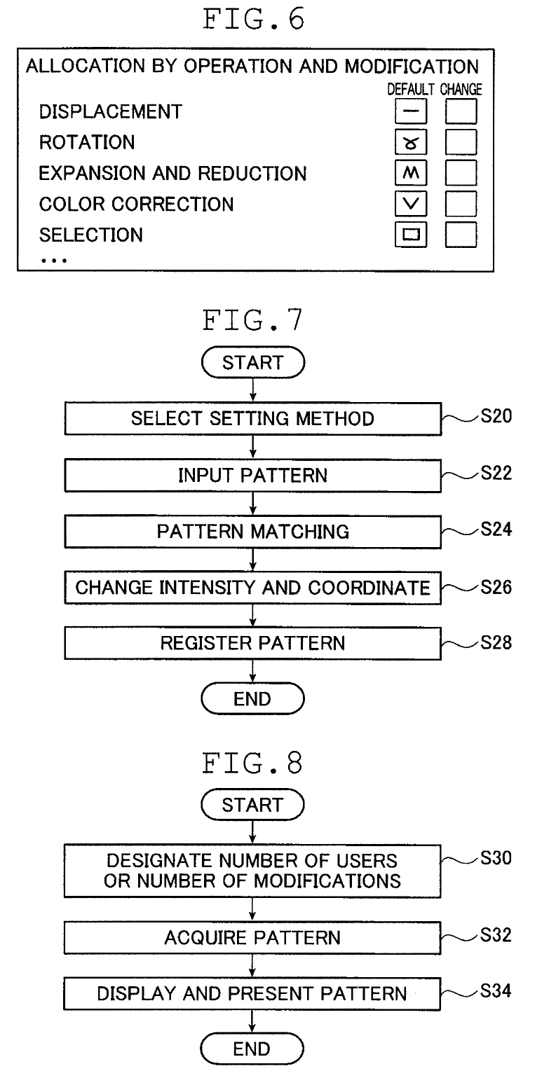

When “allocation by operation and modification” is selected on the screen illustrated in FIG. 3, a setting screen for an operation pattern for each modification illustrated in FIG. 6 is displayed. The user inputs an operation pattern for each modification (step S12 in FIG. 2). In FIG. 6, as an example, the user performs setting for modifications (or actions) for displacement, rotation, expansion and reduction, color correction, and selection in contents. Further, operation patterns may be set for each modification in the processing apparatus 10 in advance. When the operation patterns are set in advance, if the user desires to change the operation patterns, the user only has to input desired operation patterns on the screen illustrated in FIG. 6 using the operation means 14. The user can change the operation patterns as appropriate on the setting screen for operation patterns illustrated in FIG. 6.

Note that, in an example illustrated in the figure, each operation pattern of a modification is set by the pointing device such as the mouse or the touch pen. Besides, it is possible to set the operation pattern described with reference to FIGS. 4A to 4C and FIG. 5.

The operation patterns set in this way can be changed again after being registered in the pattern storing means 20. In changing the operation patterns, the user only has to input operation patterns in frames for change on the allocation screen by operation and modification illustrated in FIG. 6 using the operation means 14. In the case of setting according to allocation by person, the operation patterns can be changed in the same manner as the allocation by operation and modification.

In the setting method described above, the operation patterns to be registered in the pattern storing means 20 are input by the user. However, in the present invention, it is also possible to set operation patterns using methods illustrated in FIGS. 7 and 8.

In the setting method illustrated in FIG. 7, operation patterns are registered by using an operation pattern input by the user and existing operation patterns. In this case, the pattern allocating means 18 has a plurality of operation patterns as reference patterns in advance. An operation pattern input by the user is registered by using the reference patterns.

In steps S20 and S22 in FIG. 7, as in the case of FIG. 2, the user selects a setting method and inputs an operation pattern using the operation means 14.

Next, in step S24, the processing apparatus 10 matches the input operation pattern and the reference patterns stored in the pattern allocating means 18. A reference pattern most similar to the input operation pattern is extracted.

Then, in step S26, a difference between the input operation pattern and the reference pattern is calculated. That is, because the operation pattern input by the user has a characteristic and a tendency peculiar to the user, the characteristic and the tendency are calculated as a difference in intensity and a coordinate position. The calculated difference is added to the extracted reference pattern. Consequently, the operation pattern can be set with a change corresponding to the characteristic and the tendency of the user applied to the reference pattern.

In step S28, the reference pattern changed in this way is stored in the pattern storing means 20 together with identification information of the user to be registered as an operation pattern.

On the other hand, if the number of users who use the processing apparatus or a particular modification is designated, the processing apparatus 10 can select reference patterns at random and allocate the reference patterns to the users or the modification. A setting method in such a case is illustrated in FIG. 8.

In the setting method illustrated in FIG. 8, as in the case of FIG. 7, the pattern allocating means 18 has a plurality of operation patterns as reference patterns in advance.

In step S30 in FIG. 8, when the user selects “allocation by person” on the setting method selection screen illustrated in FIG. 3, the user inputs the number of uses who uses the processing apparatus. When the user selects “allocation by operation and modification”, the user inputs the number of modifications. The pattern allocating means 18 extracts the input number of the reference patterns stored therein. The pattern allocating means 18 allocates the respective reference patterns to the respective users and the respective modifications at random.

When the allocation process ends, the pattern allocating means 18 associates the allocated reference patterns with identification information of the users or the modification to store in the pattern storing means 20. In addition, the display means 16 displays the allocated reference patterns and the identification information of the users or the modification in association with each other to present a registration result to the user (step S34).

In the case of the setting method illustrated in FIG. 8, the user does not need to input operation patterns and can more easily register operation patterns.

Alternatively, the allocation by person and the allocation by operation and modification may be combined to register operation patterns of the respective modifications for each user. An example of such registered operation pattern is illustrated in Table 1.

In Table 1, “XXX” is registered as an operation pattern of the user A. This is an operation pattern allocated to the user A in the allocation by person. Further, “YYY” and “ZZZ” are registered as operation patterns of the user B. Those are operation patterns when the user B performs “selection” and “expansion and reduction”, respectively. When “YYY” is input as an operation pattern, the pattern recognizing means 22 searches through the pattern storing means 20 to thereby recognize that this operation is an instruction for executing “selection” action by the user B.

TABLE 1

| | User | | | |
|---|---|---|---|---|
| | Identification | | Operation | Auxiliary |
| # | Information | Operation | Pattern | Information |
| 1 | A | | XXX | |
| 2 | B | Selection | YYY | Coordinate |
| | | | | Correction |
| 3 | B | Expansion and | ZZZ | Intensity |
| | | Reduction | | Correction |

When registration is performed by using the reference patterns described with reference to FIG. 7, it is preferable to register, as an operation pattern, a reference pattern most similar to an input operation pattern and register, as auxiliary information, difference information between the input operation pattern and the reference pattern such as a difference in intensity and a coordinate position due to a tendency and the like of the user.

As the auxiliary information, besides the identification information of the user, a face image of the user, a history of use of the processing apparatus and the like may be stored as information concerning the user. Further, not only actual data but also, for example, link information to data and various kinds of information may be stored.

When the registration and setting of the operation patterns are performed as described above, the user can perform various modifications of contents by inputting the set operation patterns using the operation means 14 in the processing apparatus 10.

A method of recording details of modifications to contents by the user in the processing apparatus 10 is described.

First, a case where setting according to allocation by person is performed on the setting method selection screen for an operation pattern illustrated in FIG. 3 is described.

When the user applies modifications to contents, first, the user performs operation of an operation pattern registered as a setting method using the operation means 14 and then performs instruction for the modifications.

For example, when the user A performs the setting illustrated in FIG. 4A and then performs a modification, the user A touches the touch panel with one finger and performs instruction for the a modification of contents.

When the user inputs the operation pattern and performs the instruction for the modification, the pattern recognizing means 22 recognizes the input operation pattern and retrieves an operation pattern matching the input operation pattern out of the operation patterns registered in the pattern storing means 20. Further, the pattern recognizing means 22 extracts identification information of the user corresponding to the retrieved operation pattern.

Consequently, the pattern recognizing means 22 can recognize the user who performs the instruction for the modification.

Once the user is recognized, the operation executing means 24 executes the input instruction for the operation.

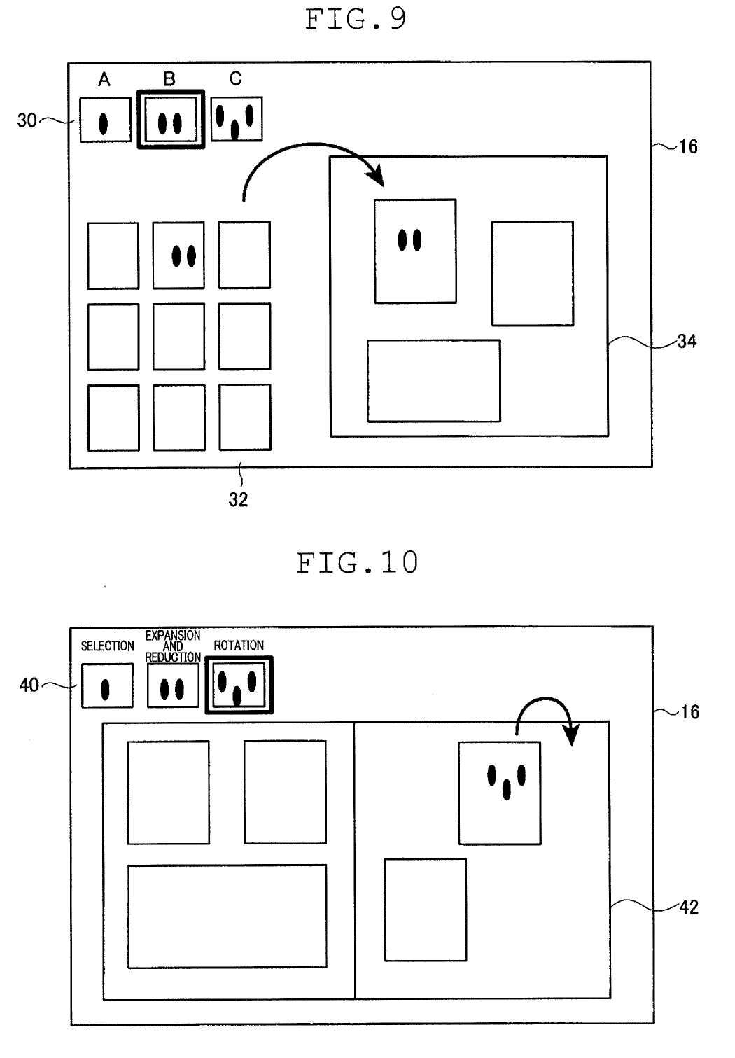

An example of a screen displayed on the display means 16 during execution of a modification to a content is illustrated in FIG. 9.

FIG. 9 illustrates, as an example, a case where the contents are images. The user B performs a modification for selecting one image out of a group of images and arranging the image on a page of an album.

A pattern display field 30, an image group display field 32, and an album layout field 34 are displayed on the display means 16 illustrated in FIG. 9.

Further, an operation pattern set for the user B is, as displayed in the pattern display field 30, a pattern of touching the touch panel with two fingers.

In FIG. 9, operation patterns allocated to the respective users are displayed in the pattern display field on the upper left of the screen. When the user B inputs the operation pattern of the user B, in the pattern display field 30, the input of the operation pattern of the user B is visually indicated by a method of, for example, changing a color of a display field for the operation pattern of the user B, displaying a frame of the display field, flashing light, or displaying a check mark. Note that, when a plurality of operation patterns are set for one user, all the set patterns may be displayed.

Subsequently, when the user B selects an image out of the group of images and arranges the image on the album, the operation pattern of the user B is displayed on the selected image and in an arrangement position of the album. It is seen from such display that those modifications are performed by the user B.

When the processing of the contents by the user B is performed in this way, the operation-information recording means 26 records information concerning details of the executed modifications and the user who performed the processing.

In the recording, identification information of the user or identification information of the operation pattern and the information concerning the modification details have to be recorded in association with each other.

Consequently, it is possible to store the details of the executed modifications for every user.

A method of recording details of modifications of contents when setting according to the allocation by operation and modification is performed on the setting method selection screen for an operation pattern illustrated in FIG. 3 is described.

When the user applies a modification to a content, the user instructs the modification by performing operation of an operation pattern corresponding to the modification that the user desires to perform among the operation patterns set in the pattern storing means 20.

When the user inputs the operation pattern and performs the instruction for the modification, the pattern recognizing means 22 recognizes the input operation pattern and retrieves an operation pattern matching the input operation pattern out of the operation patterns registered in the pattern storing means 20. Further, the pattern recognizing means 22 extracts identification information corresponding to the retrieved operation pattern.

Consequently, the pattern recognizing means 22 can recognize details of the modification on the basis of the operation pattern.

When the details of the modification can be recognized, the operation executing means 24 executes the modification corresponding to the input operation.

An example of a screen displayed on the display means 16 during execution of a modification to a content is illustrated in FIG. 10.

FIG. 10 illustrates, as an example, a case where the contents are images. The user performs a modification for rotating one image out of images laid out on an album.

A pattern display field 40 and an album layout field 42 are displayed on the display means 16 illustrated in FIG. 10.

Further, an operation pattern set for a rotation modification, as displayed in the pattern display field 40, a pattern of touching the touch panel with three fingers.

In FIG. 10, operation patterns allocated to the respective modifications are displayed in the pattern display field at the upper left of the screen. When the user inputs an operation pattern of a modification that the user desires to perform, in the pattern display field 40, the display of the input operation pattern is changed in the same manner as the case illustrated in FIG. 9.

Subsequently, when the user selects an image to be rotated out of the images arranged on the album, an operation pattern of rotation is displayed on the selected image and the image is rotated.

When the modification of the contents by the user is performed in this way, the operation-information recording means 26 records details of the executed modification. When the details of the modification are recorded, it is desirable to also record details of the modification.

The modification of the contents may be performed by using both the operation pattern allocated by person and the operation pattern allocated by operation and modification. An example of modification details recorded in the operation-information recording means 26 is illustrated in Table 2.

TABLE 2

| # | User | Operation | Detailed Information |
|---|---|---|---|
| 1 | A | Movement | Move image XX from (x1, y1) to (x2, y2) |
| 2 | B | Selection | Select image ZZ |
| 3 | B | Rotation | Rotate image ZZ 90° to the right |
| 4 | C | Color | Color correction for image YY |
| | | Correction | |

As described above, with the content processing apparatus and the content processing method according to the present invention, the user can arbitrarily set a method in inputting information for user identification necessary during modification of contents and an instruction for the modification. Therefore, the user can perform modification operation for the contents in a form more convenient for the user. Even when a plurality of users apply modifications to the same contents, it is possible to record and manage which user performs what modification and prevent operations from becoming complicated.

The content processing apparatus and the content processing method according to the present invention have been described in detail. However, it goes without saying that the present invention is not limited to the various embodiments described above and may be variously improved and modified without departing from the spirit of the present invention.

What is claimed is:

1. A content processing apparatus comprising:
at least one operation means for performing an operation instruction for contents;
pattern allocating means for allocating corresponding pattern identification information to an operation pattern of said at least one operation means;
pattern storing means for storing the operation pattern and the pattern identification information allocated to the operation pattern related to each other;
pattern recognizing means for acquiring, when the operation instruction by said at least one operation means is performed, the pattern identification information based on the operation pattern of the operation instruction by said at least one operation means and the operation pattern stored in said pattern storing means; and
operation executing means for executing processing of the contents based on the operation instruction by said at least one operation means.

2. The content processing apparatus according to claim 1, wherein said pattern allocating means allocates the pattern identification information to the operation pattern of said at least one operation means.

3. The content processing apparatus according to claim 1, wherein said pattern allocating means automatically sets the operation pattern operable in said at least one operation means and allocates the pattern identification information to the set operation pattern at random.

4. The content processing apparatus according to claim 1, wherein the pattern identification information is identification information of a user.

5. The content processing apparatus according to claim 1, wherein the pattern identification information is identification information of details of an operation instruction of said at least one operation means.

6. The content processing apparatus according to claim 1, further comprising reference-pattern storing means for storing, as reference patterns, a plurality of operation patterns set in advance, wherein
said pattern storing means extracts a reference pattern most similar to an operation pattern of said at least one operation means out of the reference patterns and stores the extracted reference pattern, a difference between the reference pattern and the operation pattern of said at least one operation means, and the pattern identification information related to one another.

7. The content processing apparatus according to claim 1, further comprising pattern changing means for changing setting of the operation pattern stored in said pattern storing means.

8. The content processing apparatus according to claim 1, further comprising recognition-result displaying means for displaying the identification information acquired by said pattern recognizing means and the operation pattern.

9. The content processing apparatus according to claim 1, wherein processing of the contents by said at least one operation means is selection or editing processing of the contents.

10. The content processing apparatus according to claim 1, further comprising operation-information recording means for recording details of the processing executed by the operation executing means related to the pattern identification information.

11. The content processing apparatus according to claim 1, wherein:
said at least one operation means performs the operation instructions for the contents via a network; and
at least one user accesses the contents via the network by using said at least one operation means and performs processing of the contents.

12. A content processing method comprising:
performing an operation instruction for contents by using at least one operation means;
allocating corresponding pattern identification information to an operation pattern of said at least one operation means;
storing the operation pattern and the pattern identification information allocated to the operation pattern related to each other;
acquiring, when the operation instruction is performed by using said at least one operation means, the pattern identification information based on the operation pattern of the operation instruction and the operation pattern stored related to the pattern identification information; and
executing processing of the contents based on the operation instruction.
